(19) United States
(12) Patent Application Publication
(10) Pub. No.: US 2015/0012167 A1
(43) Pub. Date: Jan. 8, 2015

(54) CONTROL DEVICE FOR AN AUTONOMOUS LAND VEHICLE

(71) Applicant: Ford Global Technologies, LLC, Dearborn, MI (US)

(72) Inventor: Stefan WOLTER, Aachen (DE)

(21) Appl. No.: 14/324,002

(22) Filed: Jul. 3, 2014

(30) Foreign Application Priority Data
Jul. 8, 2013 (DE) 10 2013 213 339.1

(51) Int. Cl. B60W 50/00; G05D 1/02

(52) U.S. Cl. CPC B60W 50/00; G05D 1/021; B60W 2050/0002
USPC 701/23

(57) ABSTRACT

A control device for an autonomous land vehicle, in particular truck or passenger car, which controls actuators of the vehicle to perform autonomous navigation on the basis of surroundings data acquired by sensors. The control device controls the actuators in accordance with input from the sensors and with a desired driving behavior selected by a vehicle occupant from among several available driving behaviors, such as defensive driving, moderate driving, economical driving or sporty driving.

### CROSS-REFERENCE TO RELATED APPLICATIONS

This application claims foreign priority benefits under 35 U.S.C. §119(a)-(d) to DE 10 2013 213 339.1 filed Jul. 8, 2013, which is hereby incorporated by reference in its entirety.

### TECHNICAL FIELD

The invention relates to a control device for an autonomous land vehicle, such as a truck or passenger car, which controls actuators of the vehicle to perform autonomous navigation on the basis of surroundings data acquired by means of sensors.

### BACKGROUND

It is generally known that it has become possible to let vehicles, in particular trucks and passenger cars, control and drive themselves automatically.

Such vehicles which are referred to as autonomous vehicles can navigate freely (that is to say without human intervention). Such vehicles can perceive their surroundings by various sensors and determine their position on the basis of the acquired information, aim for a destination and avoid collisions on the way (cf. Wikipedia.de “Autonomes Landfahrzeug [autonomous land vehicle]”).

Autonomous vehicles are not equivalent with unmanned vehicles since the latter term is generally used to describe those vehicles that do not navigate freely, but rather are remotely controlled by humans or computers.

Corresponding autonomous passenger cars are, for example, known from Google [cf. http://en.wikipedia.org/wiki/Google_driverless_car).

However, it is not straightforward for autonomous vehicles to adapt themselves independently to the traffic conditions and the desires of the vehicle occupants.

For example, the traffic flow and the driving habits both of individual drivers as well as generally in different regions and countries differ greatly. In this context driving styles can be categorized according to various criteria, for example as defensive, aggressive, passionate, sporty, environmentally conscious, economical etc. Corresponding differences are found throughout the world.

It is therefore necessary to make available a possible way for the autonomous land vehicles to be able to adapt to the local traffic conditions and/or the requirements of the vehicle occupants.

### SUMMARY

According to the invention, driving style parameters for the driving behavior are predefined to the control device making it possible to adapt the autonomous vehicle more easily and in an improved way to the local traffic habits and/or the requirements of the vehicle occupants, which in turn leads to safer and more adapted driving behavior of the autonomous vehicle.

In other words, the autonomous vehicle differs in terms of how it is to be driven or may drive on the basis of the surroundings data from the sensors, the driving style parameters for the driving behavior being taken into account.

The driving style parameters for the driving behavior may appropriately define defensive driving, moderate driving, economical driving or sporty driving.

Possible driving style parameters are, for example, the characteristic curve for the engine controller, curve radii during steering, distance from other vehicles and obstacles, braking decelerations, load changes, accelerations etc.

It is particularly preferred if the control device comprises an input unit for the predefinition of the driving style parameters by the vehicle occupants. Therefore, the vehicle occupant can also introduce his personal preferences into the driving behavior of the otherwise autonomous vehicle.

Alternatively, algorithms could be provided in the control device, which algorithms permit automatic adaptation to the driving behavior of the other road users and the prevailing traffic flow. In this context, sensor data of the vehicle itself and/or information from a vehicle-to-vehicle (car-to-car) communication and/or a vehicle-to-infrastructure communication can be used.

The control device will therefore actuate the actuators differently given the same surroundings data depending on the driving style parameter predefinition. Possible vehicle actuators are the steering wheel, brakes, engine etc.

It may in some circumstances be advantageous if the control for the autonomous driving can be overwritten by other commands at certain times. Such commands may be short-term or spontaneous inputs by the vehicle occupants, for example relating to the speed and direction. Alternatively, such commands may be predefined from superordinate traffic steering and control devices, as a result of which, for example, diversions, stops at traffic lights, speed limits, overtaking prohibitions etc. are prescribed.

Further features and details of the invention emerge from the following description of the drawing in which:

### BRIEF DESCRIPTION OF THE DRAWINGS

FIG. 1 is a schematic illustration of a vehicle control device according to the present invention.

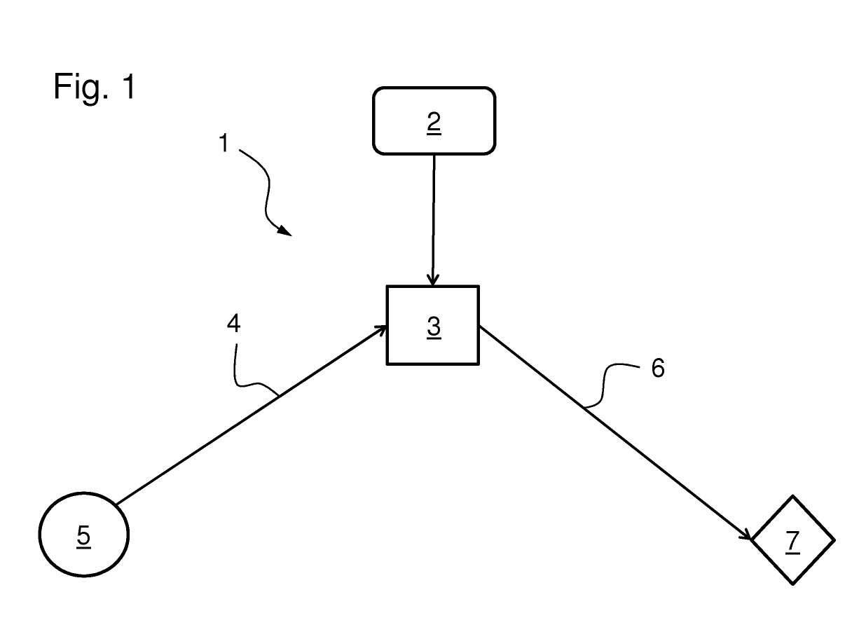

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle control device which is denoted in its entirety by 1 is shown in the single FIGURE.

Said vehicle control device comprises an input interface 2 used by the vehicle occupants for the selection of a desired driving behavior, a central automatic controller 3 for the autonomous driving and interfaces 4 for integrating sensors 5 and interfaces 6 for the closed-loop control of actuators 7.

The vehicle occupants therefore designate their selection of the driving behavior (defensive, moderate, sporty or economical) via the input interface 2, whereupon the automatic controller 3 for the autonomous driving takes into account the driving style parameters predefined in this way during the autonomous navigation, for which purpose the data are input from the sensors 5 into the computational determination of the “driving”.

Accordingly, closed-loop control of the actuators 7 is performed by the automatic controller 3 via the interfaces 6 in order to carry out the autonomous navigation while taking into account the driving behavior selected by the vehicle occupants.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A control device for an autonomous land vehicle which controls actuators of the vehicle to perform autonomous navigation based upon surroundings data acquired by sensors, wherein driving style parameters for a driving behavior are selected by a vehicle occupant, and the control device controls the actuators differently given identical surroundings data depending on the selected driving style parameters.

2. The control device of claim 1, wherein the driving style parameters for the driving behavior define defensive driving, moderate driving, economical driving or sporty driving.

3. The control device of claim 1, wherein the control device comprises an input unit operable by the vehicle occupant to predefine the driving style parameters.

4. A control device for an autonomous land vehicle comprising:
a sensor acquiring data related to surroundings of the vehicle;
an input interface used by a vehicle occupant to select a desired driving behavior from a plurality of available driving behaviors; and
an automatic controller in electronic communication with the sensor and with the input interface, and operative to control actuators of the vehicle to perform autonomous navigation based upon the data acquired by the sensor and the desired driving behavior.

5. A method for controlling an autonomous land vehicle comprising:
operating a sensor to acquire data related to surroundings of the vehicle;
allowing a vehicle occupant to select a desired driving behavior from a plurality of available driving behaviors; and
operating an automatic controller to control actuators of the vehicle to perform autonomous navigation based upon the data acquired by the sensor and the desired driving behavior.
